(19) United States
(12) Patent Application Publication
(10) Pub. No.: US 2010/0177337 A1
(43) Pub. Date: Jul. 15, 2010

(54) SELECTIVE ROUTING OF MEDICAL PRINTING REQUESTS

(75) Inventors: CHARLES F. SCHNEIDER, Trimble, MO (US); BRITTON K. JENNINGS, Smithville, MO (US); KHALOD KELANTAN PELEGRIN, Leawood, KS (US); WESLEY P. BAKER, Olathe, KS (US); PHILIP CHEN, Kansas City, MO (US)

Correspondence Address: SHOOK, HARDY & BACON L.L.P.;(Cerner Corporation), Intellectual Property Department, 2555 GRAND BOULEVARD, KANSAS CITY, MO, 64108-2613, US

(73) Assignee: CERNER INNOVATION INC., OVERLAND PARK, KS (US)

(21) Appl. No.: 12/351,659

(22) Filed: Jan. 9, 2009

(51) Int. Cl. G06F 3/12

(52) U.S. Cl. 358/1.15

(57) ABSTRACT

A computer system and method for selectively routing a printing request to the appropriate printer or printing component is provided. Patient-related and treatment-related information are received. The patient-related and/or treatment-related information are utilized to determine required printing features for the printing request, such as, for example, tamper-proof paper. The print request is routed to a printer having the required printing feature or features.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

Oftentimes in a healthcare environment, it is necessary to prescribe a patient a medication or other medical treatment. In most cases, the prescription is given, filled, and used pursuant to the instructions of a medical healthcare professional. However, this is not always the case and prescription fraud is now a growing problem in the United States and abroad. Criminals commit prescription fraud in numerous ways, including forging prescriptions, altering prescriptions to increase the quantity, or the like. However, not all medications have an equal likelihood of being sought by fraudulent means. On the contrary, medications that are more likely to be abused (e.g., oxycodone) are much more likely than other medications (e.g., pregabalin) to be the subject of a fraudulent scheme.

Due to the high cost associated with some prescription drugs, financial providers are defrauded out of millions of dollars per year covering fraudulent prescription claims. Similarly, many governmental entities are defrauded out of public funds covering claims made to governmental insurance agencies. In addition to the resources expended on fraudulent claims, state and national governments expend countless resources investigating, prosecuting, and incarcerating criminals involved in prescription fraud. To reduce financial exposure related to these and other costs of prescription fraud, many governmental and private institutions require medical healthcare professionals to use special fraud-resistant techniques. Fraud-resistant techniques are designed to prevent prescription fraud by employing devices that limit or eliminate the possibility of prescription fraud.

One common technique includes issuing prescriptions on a special type of paper, that is resistant to criminal tampering (“tamper-proof paper”). Tamper-proof paper may employ any one of a number of security devices, such as, for example, thermochromic ink, fluorescent fibers, security watermarks, reactive fibers that react to attempted alterations, or the like. As a result of many of these security features, tamper-proof paper is considerably more expensive than non-tamper-resistant paper (e.g., standard paper). As such, it would reduce healthcare costs to selectively use tamper-proof paper where necessary to prevent prescription fraud and/or comply with a statutory, regulatory, or contractual obligation to do so. In all other circumstances, it would reduce healthcare costs to utilize standard (e.g., non-tamper-resistant) paper.

### SUMMARY

In one embodiment, a computer-implemented method for selectively routing a printing request to a printer within a number of printers is provided. The method includes receiving patient-related information from an electronic medical record. The method further includes receiving treatment-related information. The method further includes identifying a printer within the number of printers having a required printing feature for the printing request utilizing the patient-related information and the treatment-related information to determine the required printing feature. This also includes routing the printing request to the identified printer. The method still further includes printing said routed printing request from said identified printer.

In another embodiment, a computer-implemented method for selectively routing a prescription printing request for a patient to a printer within a number of printers is provided. The method includes receiving patient-related information associated with the patient from an electronic medical record. The patient-related information includes a patient address or a patient's financial provider. The method also includes receiving treatment-related information associated with the patient. The treatment-related information includes a medical treatment order or an order to take medication. The method further includes determining whether tamper-proof paper is required because of said patient-related information or treatment-related information. Tamper-proof paper is required because of said patient-related information or treatment-related information if there is a legal, regulatory, or contractual requirement to utilize tamper-proof paper because of either the patient-related information or treatment-related information. The method still further includes identifying a printer within the number of printers having tamper-proof paper. The method also includes routing the printing request to the identified printer. The method still further includes printing said routed printing request from said identified printer, wherein the printing results in a printed prescription embodied on tamper-proof paper.

In another embodiment, a computer system for selecting a default printing component from a number of default printing components is provided. The system includes a receiving component that receives patient-related information or treatment-related information. The system also includes a first default printing component having a first default printing feature and a second default printing component having a second default printing feature. The first default printing feature and the second default printing feature are different. The system further includes an obtaining component that obtains information concerning a required printing feature associated with the received patient-related information or the received treatment-related information. The method still further includes a comparing component for comparing the received patient-related information or the received treatment-related information to the obtained information concerning a required printing feature. The system still also includes a selecting component that selects a default printing component having the required printing feature from the number of default printing components.

### BRIEF DESCRIPTION OF THE DRAWINGS

The present invention is described in detail below with reference to the attached drawing figures, wherein:

FIG. 1 is a block diagram illustrating components of a system for use in accordance with an embodiment of the present invention;

FIG. 2 is a block diagram illustrating components for a system for selecting a default printing component from a number of default printing components in accordance with an embodiment of the present invention;

FIG. 3 is a flow diagram illustrating a method for routing a printing request to a printing component having a required printing feature in accordance with an embodiment of the present invention; and

FIG. 4 is a flow diagram illustrating a method for routing a prescription printing request for a patient to a printer having tamper-proof paper in accordance with an embodiment of the present invention.

### DETAILED DESCRIPTION

Embodiments of the present invention are directed to systems and methods for selectively routing a print request to a printing component or printer having a required printing feature, such as, for example, tamper-proof paper. The systems and methods of the present invention not only have the ability to discern a required printing feature based on various patient- and/or treatment-related information, but also selectively route a print request to a default printing component having a required printing feature within a set of printers having different printing features.

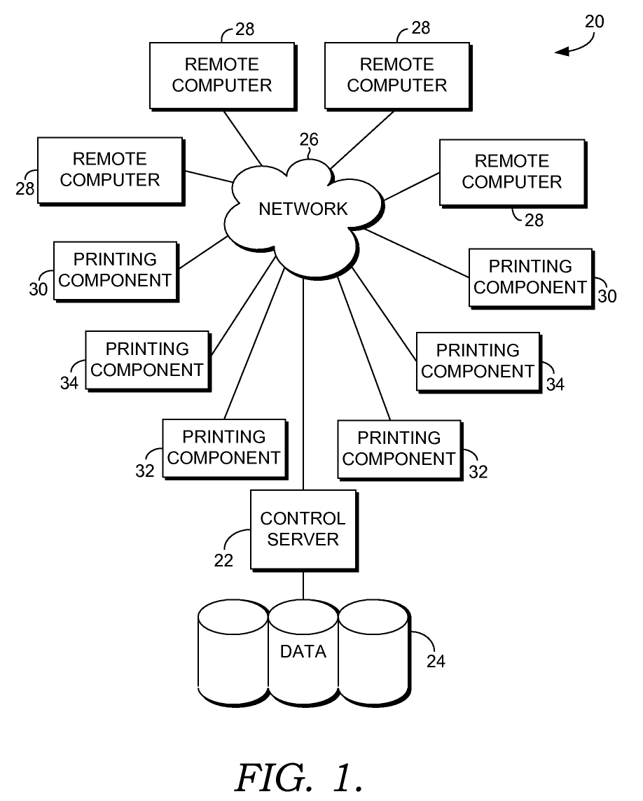

Having briefly described an overview of the present invention, embodiments of the invention will be discussed with reference to FIGS. 1-4.

With reference to FIG. 1, an exemplary medical information system for implementing embodiments of the invention includes a general purpose-computing device in the form of server 22. Components of server 22 may include, but are not limited to, a processing unit, internal system memory, and a suitable system bus for coupling various system components, including database cluster 24 to the server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer-readable media, for instance, database cluster 24. Computer-readable media can be any available media that can be accessed by server 22, and include both volatile and nonvolatile media, removable and non-removable media. By way of example, and not limitation, computer readable media may comprise computer storage media and communication media. Computer storage media includes volatile and nonvolatile, removable and nonremovable media implemented in any method or technology for storage of information, such as computer-readable instructions, data structures, program modules or other data. Computer storage media include, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media such as acoustic, RF, infrared, and other wireless media. Combinations of any of the above should also be included within the scope of computer-readable media.

The computer storage media, including database cluster 24, discussed above and illustrated in FIG. 1, provide storage of computer-readable instructions, data structures, program modules, and other data for server 22.

Server 22 may operate in a computer network 26 using logical connections to one or more remote computers 28. Remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environments and home healthcare environments. Clinicians include, but are not limited to, the treating physician, specialists such as surgeons, radiologists and cardiologists, emergency medical technologists, discharge planners, care planners, physician's assistants, nurse practitioners, nurses, nurse's aides, pharmacists, dieticians, microbiologists, laboratory experts, laboratory scientists, laboratory technologists, genetic counselors, researchers, veterinarians, and the like.

The remote computers may also be physically located in nontraditional medical care environments so that the entire healthcare community is capable of integration on the network. Remote computers 28 may be a personal computer, server, router, a network PC, a peer device, other common network node, or the like and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet.

In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

Server 22 may also operate in a computer network 26 using logical connections to one or more printing components 30, 32, 34. Printing components 30, 32, 34 can also be located at a variety of locations in a medical or research environment, for example, but not limited to, clinical laboratories, hospitals, other inpatient settings, a clinician's office, ambulatory settings, medical billing and financial offices, hospital administration, veterinary environments, and home healthcare environments. Any location suitable for remote computers 28 may also be suitable for printing components 30, 32, 34.

Printing components 30, 32, 34 may include printers, printers having multiple trays, or the like. Each of printing components 30, 32, 34 may have a unique printing feature for use with a desired printing request. For example, printing component 30 may print on standard printing paper while printing component 32 may print on tamper-proof paper. Similarly, printing component 34 may optionally print on paper having some desired seal and/or watermark. By further example, one printing component may optionally have a number of printing trays, each printing tray having a separate printing feature or printing features. As such, one printing component may optionally have a number of trays, with one tray having standard printing paper, another tray having tamper-proof paper, and a third tray having paper with some other desired feature (e.g., seal and/or watermark). Those of skill in the art will recognize that the printing features of printing components 30, 32, 34 are varied.

In the networked environment, printing requests may be made by any of the remote computers 28, routed to any of printing components 30, 32, 34, and printed with a desired and/or required printing feature. For example, and not limitation, a user of a remote computer 28 may convey a command to print a printing request for a prescription to a printing component having tamper-proof paper. It will be appreciated that the network connections shown are exemplary and other means of establishing a communications link between the computers and the printing components may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, scanner, or the like. Server 22 and/or remote computers 28 may have any sort of display device, for instance, a monitor. In addition to a monitor, server 22 and/or remote computers 28 may also include other peripheral output devices, such as speakers and printers.

Although many other internal components of server 22, remote computers, and printing components 30, 32, and 34 are not shown, those of ordinary skill in the art will appreciate that such components and their interconnection are well known. Accordingly, additional details concerning the internal construction of server 22, remote computer 28, and printing components 30, 32, and 34 need not be disclosed in connection with the present invention. Although the method and system are described as being implemented in a LAN operating system, one skilled in the art would recognize that the method and system can be implemented in any system.

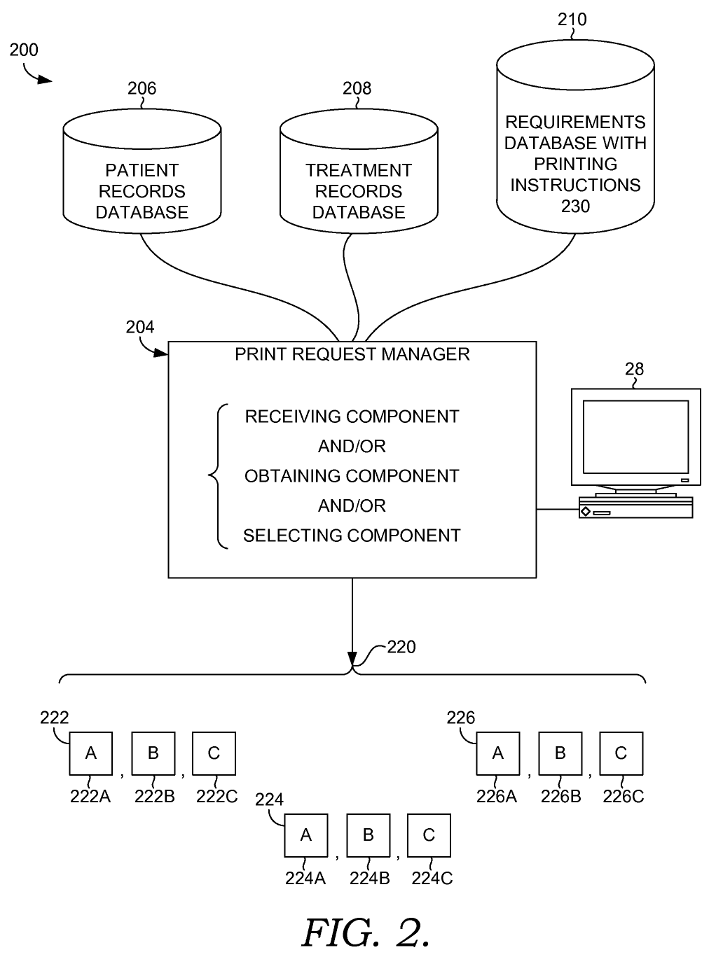

With reference to FIG. 2, a block diagram illustrates a system for selecting a default printing component from a number of default printing components in accordance with an embodiment of the present invention. A system 200 may include a print request manager 204, a patient records database 206, a treatment records database 208, and/or a requirements database 210. It will be appreciated that patient records database 206, treatment records database 208, requirements database 210 may also be stored in a common database or multiple databases.

Print request manager 204 may be in communication with or located on a remote computer 28. A user of remote computer 28 may be a healthcare provider, such as a nurse, doctor, or other healthcare worker. Print request manager 204 may optionally be in communication with one or more of the patient records database 206, the treatment records database 208, and the requirements database 210. Moreover, print request manager 204 is optionally in communication with a set of printing components 220. In one embodiment of the present invention, print request manager 204 includes a receiving component for receiving patient-related information from patient records database 206 and/or treatment-related information from treatment records database 208.

The set of printing components 220 further includes multiple subsets of printing components 222, 224, 226. Each subset of printing components 222, 224, 226 represents a grouping of all printing components within system 200 having one or more common printing features. For example, each subset of printing components 222, 224, and 226 may represent a set of printing components with certain common printing features, such as, for example, tamper-proof paper, non-tamper-proof paper (i.e., standard paper), watermarked paper, or the like. Within each subset of printing components 222, 224, 226 (e.g., 222), there may be any number of individual printing components 222A, 222B, 222C, and so on. By way of example, the set of printing components 220 may represent all the printers in a hospital (wherein the hospital represents the entire system 200). Further by example, in this hypothetical system 200, the subset of printing components 222 may represent all printing components at the hospital that have tamper-proof paper. Still by example, individual printing component 222B may represent a printer on the third-floor (or in a specific room, etc.) of the hospital having tamper-proof printing paper. As is readily apparent to those having ordinary skill in the art, there can be any number of subsets of printing components and/or printers within each subset of printing components.

In one embodiment of the present invention, system 200 includes a set of default printing components, one default printing component being selected from each subset of printing components 222, 224, 226. For example, assuming the subset of printing components 222 represents all printers in system 200 having tamper-proof paper, individual printing component 222A may be the default printing component for printing prescriptions on tamper-proof paper within system 200. Further by example, assuming the subset of printing components 224 represents all printing components in system 200 having standard (i.e., non-tamper-proof) paper, individual printing component 224C may be the default printing component for printing prescriptions on standard (i.e., non-tamper-proof) paper in system 200. In this regard, system 200 includes at least a first default printing component having for a first printing feature and a second default printing component for a second printing feature. The printing features of each default printing component are unique (i.e., different). Of course, system 200 permits overriding and/or changing the default printing component for any particular print request should a user so desire. Moreover, system 200 optionally contemplates each remote computer 28 having a unique set of default printing components to account for the varied requirements of each user (e.g., different locations, different patient needs, or the like).

Referring back to FIG. 2, patient records database 206 may include any patient-related information, such as patient demographic information, address, age, gender, weight, race, recorded problems, and a variety of other patient-related information. Moreover, patient-related information may include the patient insurance information or financial provider. Patient-related information may also include information relating to the medical health professional treating the patient, such as, the office address, licensing, or the like. Generally speaking, patient-related information may include any attribute of a patient that may require a certain printing feature. In one embodiment, patient records are stored in a patient's electronic medical record (EMR).

Treatment records database 208 may include any treatment-related information, such as, diagnoses, procedures performed, treatments, results, orders to take medication, drug schedule information, tasks, and a variety of other treatment-related information. Treatment-related information may include any attribute of a treatment regime that may require a certain printing feature. In one embodiment, treatment records are stored in a patient's electronic medical record (EMR).

Requirements database 210 contains various required printing instructions 230. The requirements database includes required printing instructions based on a variety of sources, such as, for example, statutory requirements, regulatory requirements, and/or contractual requirements. An illustrative statutory requirement may include a state, for example California, requiring certain prescriptions being printed with certain printing features (e.g., tamper-proof paper). An illustrative regulatory requirement may include a national regulatory agency, such as the U.S. Department of Health & Human Services, requiring certain patients receive all prescriptions on tamper-proof paper (e.g., all Medicare insurance recipients). An illustrative contractual requirement may include an agreement between a medical healthcare provider (e.g., a hospital, a physician, or the like) and an insurance company and/or financial provider to print certain prescriptions for certain medications on tamper-proof paper. Requirements database 210 may be updated to account for changing circumstances, such as, for example, a new national statute, a new state regulatory rule, or a new hospital policy.

Referring again to FIG. 2, print request manager 204 includes a receiving component. The receiving component of the print request manager is capable of receiving and/or accessing the patient-related information of the patient records database 206 and the treatment-related information of the treatment records database. Print request manager is further capable of communicating with each of the patient records database 206, treatment records database 208, requirements database 210 and the set of printing components 220.

Print request manager 204 further includes an obtaining component. The obtaining component of print request manager 204 obtains the required printing instructions 230 for the patient-related information accessed from patient records database 206. Similarly, the obtaining component of print request manager 204 obtains the required printing instructions 230 for the treatment-related information accessed from treatment records database 208. Required printing instructions 230 identify what patient-related information and/or treatment-related information requires printing to a printing component within the set of printing components 220 having some required printing feature. As would be apparent to those of ordinary skill in the art, the receiving component and obtaining component need not be separate components. On the contrary, any component of various embodiments of the present invention may be one or more separate components.

Print request manager 204 still further includes a selecting component. The selecting component selects an appropriate printing component for a particular printing request. To do this, the selecting component determines what, if any, printing features are required by virtue of the received patient-related information and/or treatment-related information. After isolating what printing feature or printing features are required, the selecting component isolates a printer within the set of printing components 220 having the required printing feature. In certain embodiments, the selecting component isolates the required printing feature, identifies the subset of printing components 222, 224, 226 having that required printing feature (or features), and selects the default printing component with that subset of printing components 222, 224, 226. As previously stated, any component of various embodiments of the present invention may be one or more separate components. For example, the receiving component, the obtaining component, and the selecting component may all be one component. Alternatively, the receiving component, the obtaining component, and the selecting component may all be separate. Any and all such variations are contemplated to be within the scope of embodiments of the present invention.

The printing request may represent any desired print job, such as, for example, printing a prescription. The printing request may be conveyed by a user of a remote computer 28, such as an emergency room doctor, to print request manager 204. Print request manager 204 accesses the information of patient records database 206, treatment records database 208, and requirements database 210. Information contained in the patient records database 206 or the treatment records database 208 may optionally be associated with one or more of the required printing instructions 230.

By way of example and not by limitation, print request manager 204 receives a request from a user of a remote computer 28 to print a prescription for a patient. Print request manager 204 accesses the patient records database 206 containing patient-related information and treatment-records database 208 containing treatment-related information. Alternatively, print request manager may request select information from patient records database 206 and treatment-records database 208 and, in response to this request, receive the requested information. Print request manager 204 may also access the requirements database 210 containing the various required printing instructions 230. Alternatively, print request manager may request select printing instructions 230, and, in response to this request, receive the requested printing instructions. With the information from each provided source, print request manager 204 may compare the patient-related information and the treatment-related information with the required printing instructions 230 to determine a required printing feature. Once a required printing feature has been determined, an appropriate printing component is selected. After selection, the print request is routed to a printer within a subset of printing components having the required printing feature. In one embodiment, the printing request is routed to the default printing component for the required printing feature.

In addition to the foregoing, communication between print request manager 204, patient records database 206, treatment records database 208, requirements database 210, remote computers 28, and the set of printing components 220 may be via one or more networks, which may comprise one or more wide area networks (WANs) and one or more local area networks (LANs), as well as one or more public networks, such as the Internet, and one or more private networks.

Print request manager 204 may be accessed in a variety of ways within the scope of various embodiments of the present invention. For example, in some embodiments, an entity may have a native clinical computing system, which may be able to communicate with the print request manager 204. In other embodiments, a client application associated with print request manager 204 may reside on an entity's computing device facilitating communication with print request manager 204. In further embodiments, communication may simply be a web-based communication, using, for example, a web browser to access print request manager 204 via the Internet. Any and all such variations are contemplated to be within the scope of embodiments of the present invention. In one embodiment, unified healthcare architecture, such as Cerner Millennium® by Cerner Corporation of Kansas City, Mo., may be utilized.

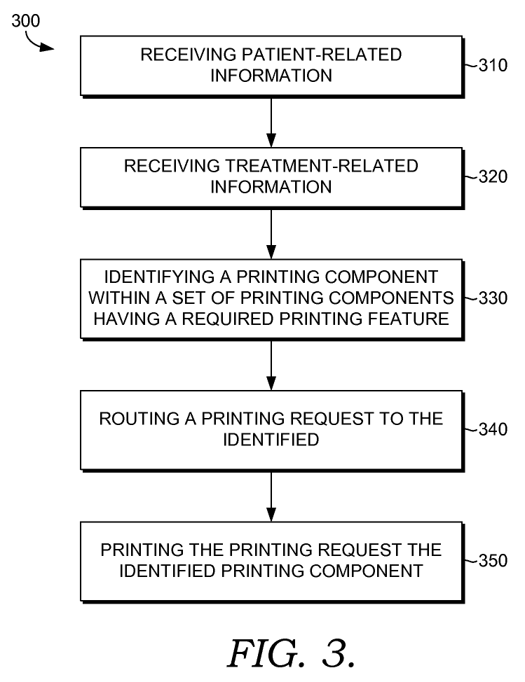

FIG. 3 is a flow diagram illustrating a method for routing a printing request to a printing component having a required printing feature in accordance with an embodiment of the present invention. At block 310, patient-related information is received. Patient-related information may include, for example, patient demographic information, address, age, gender, weight, race, recorded problems, and a variety of other patient-related information. Moreover, patient-related information may include the patient insurance information or financial provider. Patient-related information may also include information relating to the medical health professional treating the patient, such as, the office address, licensing, or the like. The patient-related information may optionally be received into a database, into a graphical user interface, or in any other manner consistent with embodiments of the present invention. For example, a patient's address, age, gender, weight, and race may be stored in an electronic medical record. Alternatively, a patient's address, age, gender, weight, and race may be entered during the initiation of a printing request. The patient-related information may optionally have certain associated printing features. For example, a patient address of California may have a required printing feature or features, whereas a patient address of Missouri does not.

At block 320, treatment-related information is received. Treatment-related information may include any treatment-related information, such as, diagnoses, procedures performed, treatments, results, orders to take medication, drug schedule information, tasks, and a variety of other treatment-related information. For example, a doctor may order a patient to take a certain medication. In addition, treatment-related information may include the scheduling information of the medication, as defined by the government. Presently, drug schedules range from I to V, depending on the potential for drug abuse, known or accepted medical uses, and/or safety for use as a medication. Drug schedule information is provided by the U.S. government and is routinely updated. As such, specific examples would be unhelpful, as the drug schedule of any particular medication may change. However, those of ordinary skill in the art would appreciate the governmental scheduling scheme. As drugs within each drug schedule are believed to possess many common attributes and/or risks, some drug schedules may have specifically required printing features. For example, some statutes or regulations may require printing all prescriptions for Schedule II drugs on tamper-proof printing paper. Moreover, some insurance companies or financial providers may require printing select drug schedules (e.g., Schedule II or III only) on tamper-proof paper.

At block 330, a printing component within a set of components is identified. As stated previously, printing components include, for example, printers, printing trays, or the like. The printing component identification of block 330 includes utilizing the received patient- and treatment-related information to discern whether there is a required printing feature. The printing component identification of block 330 may optionally utilize each discreet (i.e., separate) item of received information to determine whether any particular printing feature is required. Moreover, the printing component identification of block 330 further includes an ability to identify a printing component from a set of printing components having a common printing feature, wherein each item of information has a separate or distinct required printing feature. Thus, for example, where the patient-related information has a required printing feature of tamper-proof paper, but the treatment-related information has no required printing feature, printing component identification of block 330 may optionally utilize a priority scheme to print the print request to a printing component having tamper-proof paper.

In addition, the printing component identification of block 330 may simply include identifying several printers each having a required printing feature. In this embodiment of the present invention, the printing component identification of block 330 may optionally include manually selecting a printing component from a set of printing components having the required printing feature. Alternatively, the printing component identification of block 330 may optionally include utilizing non-patient-related and/or treatment-related information to select a printing component from a set of printing components having a required printing component. For example, if a prescription requires tamper-proof paper by virtue of the medication drug schedule, printing component identification of block 330 may select a printing component from a set of printing components having tamper-proof paper based on the physical location of the user making the print request, the backlog at particular printing components, the paper supply at particular printing components, or the like.

In an alternative embodiment, one printing component within each set of printing components having a common printing feature may be set as the default printing for that printing feature. In this embodiment, printing component identification of block 330 will include isolating a required printing feature and determining which printing component within the set of printing components having the identified printing feature is the selected default printing component for the identified printing feature. For example, if a prescription requires tamper-proof paper by virtue of the financial provider, the printing component identification of block 330 includes identifying a subset of printing components having tamper-proof printing paper. Block 330 may also include identifying the default printing component within the identified subset of printing components having tamper-proof paper. At the conclusion of the printing component identification of block 330, a printing component having a required printing feature will be identified.

Turning now to block 340, a printing request is routed to the identified printing component. Any known method of routing a printing request may be utilized. Finally, at block 350, the print request is printed by the identified printing component. The result may include a printed printing request embodied in a physical medium having one or more desired or required printing features.

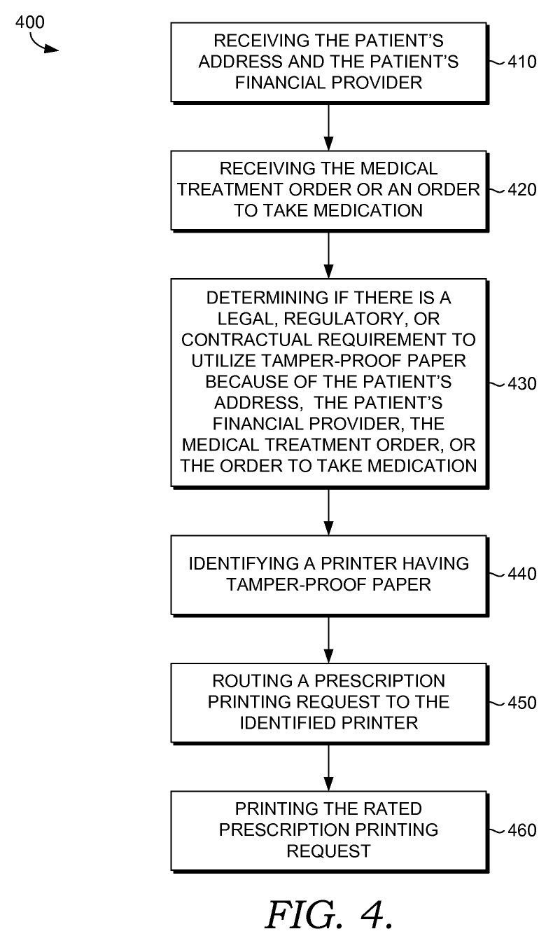

FIG. 4 is a flow diagram illustrating a method for routing a prescription printing request for a patient to a printer having tamper-proof paper in accordance with an embodiment of the present invention. At block 410, method 400 includes receiving patient-related information associated with a patient from an electronic medical record. The patient-related information of method 400 includes a patient's address and/or financial provider. The contemplated financial provider(s) of method 400 includes Medicaid and/or Medicare. At block 420, method 400 includes receiving treatment-related information associated with a patient. The treatment-related information of method 400 includes a medical treatment order and/or an order to take medication. At block 430, method 400 includes determining whether tamper-proof paper is required because of the patient's address, the patient's financial provider(s), the medical treatment order, or order to take medication. The determination at block 430 includes determining if there is a legal, regulatory, or contractual requirement to utilize tamper-proof paper because of the patient's address, the patient's financial provider(s), the medical treatment order, or order to take medication. For example, if a prescription printing request is made for a patient living in a state that requires all prescriptions to be printed on tamper-proof printing paper, block 430 would include determining that the patient's address requires tamper-proof paper. In this example, there may be either a legal or regulatory requirement to print prescriptions on tamper-proof paper, depending on the nature of the requirement (e.g., statute or regulation). By way of further example, if a prescription printing request is made for a patient using Medicaid or Medicare, block 430 may include determining that tamper-proof paper is required. In this example, there may be either a legal, regulatory, or contractual requirement to print prescriptions on tamper-proof paper, depending on the nature of the requirement (e.g., federal statute, federal regulation, or a contract with the government). Still by example, if a prescription printing request is made for a Schedule II drug, block 430 may include determining that tamper-roof paper is required because of both the order to take medication and the patient's address. In this example, the patient's home state might require printing all prescriptions for Schedule II drugs on tamper-proof printing paper. If tamper-proof printing paper is required because of any legal, regulatory, or contractual requirement, block 440 includes identifying a printer within a set of printers having tamper-proof paper. The identification at block 440 may optionally include identifying a default printer for tamper-proof paper within a set of printers having tamper-proof printing paper. At block 450, the prescription printing request is routed to the printer identified at block 440. At block 460, the prescription printing request is printed from the printer identified at block 440 resulting in a prescription embodied in a physical medium having one or more desired or required printing features.

### Specific Examples

As described above, examples of various embodiments of the present invention may include systems, methods, and computer-readable media that selectively route print requests to a printing component having a required printing feature. The various features of the present invention have been described in relation to various embodiments, which are intended in all respects to be illustrative rather than restrictive. Alternative embodiments will become apparent to those of ordinary skill in the art to which the present invention pertains without departing from its scope.

A method according to at least one embodiment of this invention includes: (a) receiving patient-related information from an electronic medical record; (b) receiving treatment-related information; (c) identifying a printer within the set of printers having a required printing feature for a printing request utilizing the patient-related information and the treatment-related information to determine the required printing feature; (d) routing the printing request to the identified printer; and (e) printing the routed printing request from said identified printer.

One system according to at least one embodiment of this invention includes: (a) a receiving component that receives patient-related information or treatment-related information; (b) a first default printing component having a first default printing feature and a second default printing component having a second default printing feature, wherein the first default printing feature and the second default printing feature are different; (c) an obtaining component that obtains information concerning a required printing feature associated with the received patient-related information or the received treatment-related information; and (d) a selecting component that selects a default printing component having the required printing feature from a set of default printing components.

In at least these embodiments of the present invention, it is helpful to discuss the manner in which a printing component is selected. For example, in the example illustrating a method, it is helpful to detail how to utilize the patient-related information and the treatment-related information to determine the required printing feature. Similarly, in the example illustrating a system, it is helpful to detail how the selecting component selects a printing component based on the received patient-related and/or treatment-related information.

For purposes of illustration only, consider the hypothetical patient list provided in Table 1:

TABLE 1
Hypothetical Patient List

| | Patient A | Patient B | Patient C | Patient D | Patient E | Patient F |
|---|---|---|---|---|---|---|
| State | State A | State B | State A | State A | State A | State A |
| Financial Provider | Provider A | Provider B | Provider B | Provider B | Provider B | Medicaid |
| Prescribed Drug | Anabolic | Anabolic | Anabolic | Hydrocodone | Hydrocodone | Alprazolam |
| | steroids | steroids | steroids | | | |
| Prescribed Drug | III | III | III | II | II | IV |
| Schedule | | | | | | |
| Other? | No | No | No | No | Yes | No |

The hypothetical patient list, of course, illustrates only a small portion of the information that would normally be included in embodiments of the invention. The data to complete the hypothetical patient list is optionally drawn from a patient records database (See FIG. 2, 206) and/or a treatment records database (See FIG. 2, 208). For example, a patient record database would include the home state of a patient. Thus, for Patient A, a home state of State A is known. Similarly, a treatment record database would optionally include information regarding a prescribed drug. Thus, for Patient E, the prescribed drug is known. As would be apparent to those of ordinary skill in the art, practicing various embodiments of the present invention does not require formulating a patient list as depicted in Table 1. However, for ease of discussion, a patient list has been provided herein.

Various embodiments of the present invention require determining whether a specific printing feature is required. The required printing features are generally included in a requirements database (FIG. 2, 210). It will be appreciated that a patient records database, a treatment records database, and/or a requirements database may be one or more actual databases.

For purposes of these examples, assume that the printing feature under examination is tamper-proof paper and the printing request is for a prescription. Assume further the following conditions are retrieved from a requirements database: State A has no requirement (statutory, regulatory, or otherwise) mandating the use tamper-proof paper; State B mandates tamper-proof paper in connection with printing any prescription; Provider A has no contractual or legal requirement mandating the use of tamper-proof paper; Provider B requires, as part of its standard contract with all approved health professionals (hospitals, or the like), that all prescriptions for Schedule II drugs will be printed on tamper-proof paper; and Medicaid mandates tamper-proof paper for any prescription printing request. Under these assumptions, the prescriptions for Patients B, D, and E, will need to be printed on tamper-proof paper. For Patient B, various systems and methods of the present invention will determine that Patient B's state (State B) and financial provider (Provider B) require printing the prescription for anabolic steroids on tamper-proof paper. Similarly, For Patient D, various systems and methods of the present invention will determine that Patient D's financial provider (Provider B) requires printing the prescription for hydrocodone (as Schedule II drug) on tamper-proof paper. Further, for Patient F, various systems and methods of the present invention will determine that Medicaid requires printing all prescriptions on tamper-proof paper, regardless of the Schedule of alprazolam.

In contrast, for Patient A, various systems and methods of the present invention will determine that Patient A's prescription for anabolic steroids can be printed on standard (i.e., non-tamper-proof) prescription paper. Similarly, for Patient C, various systems and methods of the present invention will determine that Patient C's state (State A) does not require tamper-proof paper, and Patient C's financial provider (Provider B) does not require tamper-proof paper for anabolic steroids (Schedule III drug).

After determining whether tamper-proof paper is required, various systems and methods of the present invention will identify where to route the printing request based on the determined requirements. Thus, if Patient C and Patient D were at the same hospital, for example, Patient C's prescription will be routed to the default printing component for standard paper whereas Patient D's prescription will be routed to the default printing component for tamper-proof paper. It is in this regard that the various methods and systems of the present invention include selectively routing a printing request to an appropriate printing component from a number of printing components and/or an appropriate default printing component from a number of default printing components.

The present invention has been described in relation to particular embodiments, which are intended in all respects to illustrate rather than restrict. Alternative embodiments will become apparent to those skilled in the art that do not depart from its scope. Many alternative embodiments exist, but are not included because of the nature of this invention. A skilled programmer may develop alternative means for implementing the aforementioned improvements without departing from the scope of the present invention.

It will be understood that certain features and subcombinations are of utility and may be employed without reference to other features and subcombinations and are contemplated within the scope of the claims. Furthermore, the steps performed need not be performed in the order described.

The invention claimed is:

1. A computer-implemented method for selectively routing a printing request to a printer within a plurality of printers, the method comprising:
receiving patient-related information from an electronic medical record;
receiving treatment-related information;
identifying a printer within the plurality of printers having a required printing feature for said printing request utilizing the patient-related information and the treatment-related information to determine the required printing feature;
routing said printing request to the identified printer; and
printing said routed printing request from said identified printer.

2. The method of claim 1, wherein said patient-related information comprises a patient address or patient insurance information.

3. The method of claim 2, wherein said treatment-related information comprises a medical treatment or an order to take medication.

4. The method of claim 3, wherein the required printing feature comprises tamper-proof paper.

5. The method of claim 4, wherein utilizing the patient-related information and the treatment-related information to identify a printer within the plurality of printers having a required printing feature for said printing request comprises:
determining whether tamper-proof paper is required because of said patient address or said patient insurance information;
determining whether tamper-proof paper is required because of said medical treatment or said order to take medication; and
identifying a printer within the plurality of printers having tamper-proof paper, if tamper-proof paper is determined to be required.

6. The method of claim 1, wherein said printing request comprises a plurality of printing jobs, each of said printing jobs having unique patient-related and treatment-related information.

7. The method of claim 1, wherein said required printing feature comprises tamper-proof paper or non-tamper-proof paper.

8. A computer-readable storage media containing computer-usable instructions for performing the method of claim 1.

9. A computer-implemented method for selectively routing a prescription printing request for a patient to a printer within a plurality of printers, the method comprising:
receiving patient-related information associated with the patient from an electronic medical record, wherein said patient-related information comprises a patient address or a patient's financial provider;
receiving treatment-related information associated with the patient, wherein said treatment-related information comprises a medical treatment order or an order to take medication;
determining whether tamper-proof paper is required because of said patient-related information or treatment-related information, wherein tamper-proof paper is required because of said patient-related information or treatment-related information if there is a legal, regulatory, or contractual requirement to utilize tamper-proof paper because of either the patient-related information or treatment-related information;
identifying a printer within the plurality of printers having tamper-proof paper;
routing said printing request to the identified printer; and
printing said routed printing request from said identified printer, wherein said printing results in a printed prescription embodied on tamper-proof paper.

10. The method of claim 9, wherein said printing request comprises a plurality of printing jobs, each of said printing jobs having unique patient-related and treatment-related information.

11. The method of claim 9, wherein said regulatory requirement to utilize tamper-proof paper comprises a municipal, a state, or a national regulation.

12. The method of claim 9, wherein said contractual requirement to utilize tamper-proof paper comprises an agreement to utilize tamper-proof paper under agreed conditions.

13. A computer-readable storage media containing computer-usable instructions for performing the method of claim 9.

14. A computer system for selecting a default printing component from a plurality of default printing components, comprising:
a receiving component that receives patient-related information or treatment-related information;
a first default printing component having a first default printing feature and a second default printing component having a second default printing feature, wherein said first default printing feature and said second default printing feature are different;
an obtaining component that obtains information concerning a required printing feature associated with the received patient-related information or the received treatment-related information; and
a selecting component that selects a default printing component having the required printing feature from the plurality of default printing components.

15. The computer system of claim 14, wherein the first printing feature is tamper-proof paper and the second printing feature is non-tamper-proof paper.

16. The computer system of claim 14, wherein said patient-related information comprises a patient address or patient insurance information.

17. The computer system of claim 16, wherein said treatment-related information comprises a medical treatment or an order to take medication.

18. The computer system of claim 14, wherein said patient-related information or said treatment-related information is received over a communication network from a remote computer.

19. The computer system of claim 14, further comprising:
a third default printing component having a third default printing feature, wherein said third default printing feature is different than said first default printing feature and said second default printing feature.

20. The computer system of claim 19, further comprising:
a plurality of remote computers;
a patient records database storing said patient-related information; and
a treatment records database storing said treatment-related information;
a requirements database storing printing instruction information concerning a required printing feature associated with the received patient-related information or the received treatment-related information required printing feature.
